(19) United States
(12) Patent Application Publication
(10) Pub. No.: US 2006/0048834 A1
(43) Pub. Date: Mar. 9, 2006

(54) PA/PO-PA/TPE-E multilayer pipe

(76) Inventor: Pierre Milhas, Vitry-Le-Francois (FR)

Correspondence Address: DYKEMA GOSSETT PLLC, 39577 Woodward Ave., Ste. 300, Bloomfield Hills, MI, 48304-2820, US

(21) Appl. No.: 11/221,500

(22) Filed: Sep. 8, 2005

(30) Foreign Application Priority Data
Sep. 8, 2004 (FR) 0409507

(51) Int. Cl. F16L 11/00

(52) U.S. Cl. 138/137

(57) ABSTRACT

A multilayer pipe for transporting an automobile fluid, the pipe comprising: an inner layer of polyamide; an intermediate layer based on a mixture of polyamide and of polyolefin; and an outer layer made of a thermoplastic elastomer material based on polyether-ether.

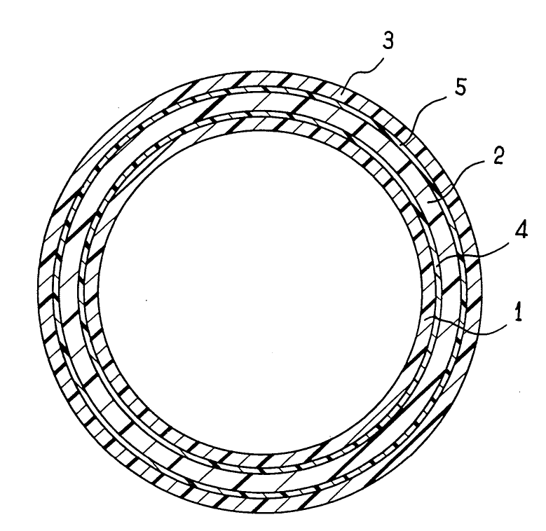

The present invention relates to a pipe for transporting automobile fluids, and more particularly for transporting fuel.

### BACKGROUND OF THE INVENTION

There exist numerous single-layer or multilayer structures based on thermoplastics materials.

Thus, single-layer structures are known made of polyamide 11 or polyamide 12 that are in relatively widespread use in spite of their high cost.

At present, respect for the environment is becoming a central concern and constitutes the subject matter of legal requirements (such as European Directive EURO 2004) with which automobile manufacturers will have to comply. In addition, technological advance is leading to toughening of the conditions of use to which pipes of this type are subjected, more particularly when they are installed in the engine compartment of the vehicle. Thus, for example, present engines operate at ever higher temperatures: the pipes installed in the engine compartment must be capable of withstanding a temperature of about 125° C. on a continuous basis. Furthermore, pipes must present good ability to withstand external aggression, and in particular chemical interactions with the substances with which the outside face of the pipe might come into contact, such as lubricants (in particular oil), cleaning liquids (in particular windshield cleaning liquids), substances for combating ice, zinc chloride, . . . . The general performance of a pipe is thus the result of a delicate compromise in response to the various different constraints.

Unfortunately, known structures based on thermoplastic material are generally poorly adapted to those new constraints.

### BRIEF DESCRIPTION OF THE INVENTION

The invention provides a multilayer pipe for transporting automobile fluids, the pipe comprising:

an inner layer of polyamide;

an intermediate layer based on a mixture of polyamide and of polyolefin; and

an outer layer made of a thermoplastic elastomer material based on polyether-ether.

This structure presents low permeability to automobile fluids such as fuels, and it also presents good resistance to the substances with which it can come into contact while in use on an automobile, and in particular with oil, zinc chloride, windshield cleaning liquids, fuel, . . . . The pipe of the invention is also adapted to operating at temperatures lying in the range 125° C. to 150° C. In addition, this pipe is relatively inexpensive.

Other characteristics and advantages of the invention will appear on reading the following description of a particular, non-limiting embodiment of the invention.

### BRIEF DESCRIPTION OF THE DRAWING

Reference is made to the sole accompanying FIGURE showing a pipe in accordance with the invention in cross-section.

### DETAILED DESCRIPTION OF THE INVENTION

With reference to the FIGURE and in accordance with the invention, the pipe has a multilayer structure comprising three main layers 1, 2, and 3 interconnected by bonding layers 5. Going from the inside towards the outside there are the inner layer 1, the first bonding layer 4, the intermediate layer 2, the second bonding layer 5, and the outer layer 3.

The inner layer 1 is made of polyamide, preferably a polyamide 6.

The intermediate layer 2 is based on a polyamide and a polyolefin. In this case, the polyamide is polyamide 6 and the polyolefin is polyethylene. The material used is that referenced Orgalloy as produced by the supplier Atofina, for example.

The outer layer is made of an thermoplastic elastomer material based on polyether-ether. By way of example the material used is that produced under the reference Riteflex by the supplier Ticona.

The first bonding layer 4 is made of a material that presents adhesive properties relative to the material of the inner layer 1 and that of the intermediate layer 3.

The second bonding layer 5 is made of a material presenting adhesive properties relative to the intermediate layer 2 and the outer layer 3.

It should be observed that the bonding layers 4 and 5 are optional when the intermediate layer presents sufficient adhesive properties relative to the material of the inner layer 1 and that of the outer layer 3 to be able to provide cohesion between the various layers when faced with the stresses that the pipe is designed to withstand.

By way of example, the inner layer 1 may be of thickness lying in the range 0.2 millimeters (mm) to 0.5 mm, approximately, the first bonding layer 4 may have a thickness of about 0.1 mm, the intermediate layer 2 may have a thickness lying in the range 0.2 mm to 0.5 mm, the second bonding layer 5 may have a thickness of about 0.1 mm, and the outer layer 3 may have a thickness lying in the range 0.2 mm to 0.4 mm, approximately.

The pipe is made by co-extrusion and may be smooth or it may be corrugated.

The pipe may be disposed in any location in a vehicle, and in particular in the engine compartment thereof or under its bodywork.

Naturally, the invention is not limited to the embodiment described and various implementations can be applied thereto without going beyond the ambit of the invention as defined by the claims.

In particular, the thicknesses are given purely by way of indication and can be modified as a function of the diameter of the pipe or so as to take account of particular conditions of use e.g. in association with the pressure of the fluid.

What is claimed is:

1. A multilayer pipe for transporting an automobile fluid, the pipe comprising:
an inner layer of polyamide;
an intermediate layer based on a mixture of polyamide and of polyolefin; and
an outer layer made of a thermoplastic elastomer material based on polyether-ether.

2. A multilayer pipe according to claim 1, wherein the polyolefin of the intermediate layer is polyethylene.

3. A multilayer pipe according to claim 1, wherein the polyamide used for the inner layer is a polyamide 6.

4. A multilayer pipe according to claim 1, including a bonding layer that is disposed between the inner layer and the intermediate layer and that possesses adhesive characteristics relative to the materials of those two layers.

5. A multilayer pipe according to claim 1, including a bonding layer that is disposed between the intermediate layer and the outer layer and that possesses adhesive properties relative to the materials of those two layers.

6. A multilayer pipe according to claim 1, wherein the inner layer is of thickness lying in the range 0.2 mm to 0.5 mm.

7. A multilayer pipe according to claim 1, wherein the intermediate layer is of thickness lying in the range 0.2 mm to 0.5 mm.

8. A multilayer pipe according to claim 1, wherein the outer layer is of thickness lying in the range 0.2 mm to 0.4 mm.

9. A multilayer pipe according to claim 4, wherein the bonding layer is of thickness of about 0.1 mm.
